(19) United States
(12) Patent Application Publication
(10) Pub. No.: US 2010/0122907 A1
(43) Pub. Date: May 20, 2010

(54) SINGLE MOLECULE MASS OR SIZE SPECTROMETRY IN SOLUTION USING A SOLITARY NANOPORE

(75) Inventors: Vincent M. Stanford, North Potomac, MD (US); John J. Kasianowicz, Darnestown, MD (US); Joseph W.F. Robertson, Washington, DC (US); Claudio G. Rodrigues, Recife (BR); Oleg V. Krasilnikov, Recife (BR)

Correspondence Address: Steve Witters, PLLC, 930 Woodland Ridge Circle, LaGrange, KY, 40031, US

(73) Assignees: GOVERNMENT OF THE UNITED STATES OF AMERICA,; AS REPRESENTED BY THE SECRETARY OF COMMERCE,; THE NATIONAL INSTITUTE OF STANDARDS AND TECHNOLOGY

(21) Appl. No.: 12/435,667

(22) Filed: May 5, 2009

Related U.S. Application Data
(60) Provisional application No. 61/050,832, filed on May 6, 2008.

(51) Int. Cl. G01N 27/447

(52) U.S. Cl. 204/451; 204/601

(57) ABSTRACT

A nanopore conductance measurement method and system is provided. The system has reservoirs of conductive fluid separated by a resistive barrier, which is perforated by a single nanometer scale pore commensurate in size with an analyte molecule in at least one of the reservoirs. The system is configured to have an ionic current driven across the reservoirs by an applied potential and the pore may be treated so that the pore surface can form associations with the analyte molecules of interest to increase the analyte molecule residence times on or in the pore. The system also comprises a means of measuring the ionic current, which current may be either direct or alternating in time, induced by an applied potential between electrodes in the conductive fluid, on each side of the barrier. The system also comprises a means of recording the ionic current time course as a time series, which includes time periods when the pore is unobstructed and also in periods when analyte molecules cause pulses of reduced conductance. The method comprises methods to delineate segments of the conductance time series into regions statistically consistent with the unobstructed pore conductance level, and pulses of reduced conductance, and also statistically stationary segments within individual pulses of reduced conductance. The method may also provide steps for interpreting the statistical analysis to yield parameters such as size, mass, and/or concentration of at least one type of analyte in solution.

### CROSS-REFERENCE TO RELATED APPLICATIONS

This application claims the benefit under 35 U.S.C. §119(e) of U.S. Provisional Application No. 61/050,832, entitled “SINGLE MOLECULE MASS SPECTROMETRY IN SOLUTION USING A SOLITARY NANOPORE”, filed May 6, 2008, which is hereby incorporated herein by reference in its entirety.

### STATEMENT REGARDING FEDERALLY SPONSORED RESEARCH OR DEVELOPMENT

This work is funded in part by the National Institute of Standards and Technology under the U.S. Department of Commerce, the Federal University of Pernambuco, Brazil, and in part by Conselho Nacional de Desenvolvimento Cientifico e Tecnologico, Brazil.

### FIELD

Aspects of the present invention generally relate to methods and apparatuses for detecting the concentrations of analytes in a solution.

### BACKGROUND

As reflected in the patent literature, reliable and economical characterization of samples of macromolecules, particularly polymers of nucleic acids (RNA and DNA), amino acids (proteins), and synthetic polymers (e.g., poly(ethylene glycol)) as to size, mass, and relative concentration of the sample components is of great interest to commercial and scientific communities. Many different technologies have been developed to detect and characterize macromolecules, including mass spectrometry and electrophoresis.

In a landmark patent, U.S. Pat. No. 2,656,508, Wallace Coulter introduced a method to detect particles suspended in solution and driven through a capillary. The number and sizes of the particles are determined by measuring electrical resistance changes in the capillary. With capillaries of diameter d ˜100 microns, the Coulter technique is widely used to count and size red and white blood cells, and platelets. More recently, mesofluidic structures and carbon nanotubes with diameters <1 micron have been used for analysis of macromolecules, colloids, and bioparticles typically ˜100 nm in diameter. Further reduction of the portal diameter may lead to phenomenological limitations by excluding flow driven with hydrostatic pressure or via electrokinetic effects. As a result, transport through nano structures may occur by diffusion or electromigration.

However, the natural useful limit of the capillary diameter is the size of the molecules of interest, and biological ion channels have diameters and lengths commensurate with molecular dimensions. The characteristic time for a molecule to diffuse the length of such pores (˜10 nm) is about 50 ns to 500 ns, which may be inaccessible for meaningful conductance measurements of nanoscale pores. Thus, the Coulter method may be inadequate for detecting particles of a smaller size.

Mass spectrometric techniques, such as Matrix-Assisted Laser Desorption/Ionization—Time Of Flight (MALDI-TOF) may provide a technology for the more precise characterization of macromolecule masses. While the MALDI-TOF apparatus and analytical method may be refined, and widely disseminated in research and development laboratories worldwide, it may be complex and may have some practical disadvantages. For example, the sample may need to be prepared in a solid phase chemical matrix, inserted into a vacuum chamber, flashed with a pulse laser to bring the molecules into gas phase, and accelerated by an electric field. This process may cause fragmentation of the analyte molecules that may complicate the interpretation of mass spectrograms, and also may consume the analyte sample. Additionally, the apparatus used in the MALDI-TOF technology may not be miniaturized to the nano scale, and thus may not be suitable to highly parallel lab-on-a-chip applications. Further, mass spectrometry techniques typically require adding electric charge to the analyte via the addition of a charged component (e.g., H+) and bringing the analyte molecules into the gas phase. The sample, or a portion of it, may be consumed during the measurement process. Also, the methods of the prior art may require a large sampling volume or require that the analytes be bound to an immobile surface.

What is needed are alternative methods and apparatus for detecting parameters of analytes in a solution.

### SUMMARY

Aspects of the invention generally include a nanopore conductance measurement system comprised of: a.) Reservoirs of conductive fluid separated by a resistive barrier, which barrier is perforated by a single nanometer scale pore commensurate in size with analyte molecules; and which pore allows ionic current to be driven across the reservoirs by an applied potential, and which pore may be treated so that the pore surface may form associations with the analyte molecules of interest to increase the analyte molecule residence times on or in the pore. The pore (that may be chemically modified to optimize pore-analyte interactions) and barrier combination may be any of the following: i) A proteinaceous pore, such as α-hemolysin made by S. aureus, or by means of molecular biology passing through a bilayer lipid membrane barrier, or other self assembling chemical barrier such as block co-polymer liquid crystal, or; ii) A pore non-biological origin, such as a carbon nanotube, or one fabricated using synthetic chemistry, passing through a biological membrane, or; iii) A proteinaceous pore, possibly of biological origin, passing through a self assembling block co-polymer resistive barrier, or; iv) A pore formed in an inorganic resistive barrier, such as silicon or silicon nitride, by removing material from the barrier to create a nanometer scale opening, or; v) A pore of non-biological origin, such as a carbon nanotube, passing through a pore formed as in iv) above in an inorganic resistive material; and b) A means of measuring the ionic current, which current may be either direct or alternating in time, induced by the applied potential of 1a, and a means of recording its time course as a time series, to include time periods when the pore is unobstructed and also in periods when analyte molecules cause pulses of reduced-conductance.

Another aspect of the present invention discloses a method to delineate segments of the conductance time series of the means of measuring the ionic current, into regions statistically consistent with the unobstructed pore conductance level, and pulses of reduced-conductance, and also statistically stationary segments within individual pulses of reduced-conductance, which method may embodied as: a.) A Viterbi decoding of the maximum likelihood state sequence of a Continuous Density of a Hidden Markov Model (CDHMM) estimated from the raw conductance time series or; b.) A delineation of the regions of pulses of reduced-conductance via comparison to a threshold for deviation from the open-pore conductance level or; c.) Other methods of time series segmentation well known to those reasonably skilled in the arts.

In yet another aspect of the present invention, within the segments identified by the method to delineate segments of the conductance time series, a means to characterize pulses of reduced-conductance by estimating the central tendencies of the ionic current levels for each segment, or by measure of central tendencies and segment duration together. The measure of segment central tendency may be: a.) A mean parameter of a Gaussian component of a first Gaussian Mixture Model (GMM) estimated from the raw conductance time series as part of a Continuous Density Hidden Markov Model or; b.) An arithmetic mean or; c.) A Trimmed Mean or; d.) A median or; e.) Another measure of central tendency, such as a Maximum A Posteriori estimator of sample location, or a maximum likelihood estimator of sample location well-known to those skilled in the arts.

In a further aspect of the present invention, a means to identify conductance spectrum components in the empirical probability density of the estimates of central tendencies of conductance time series segments is provided, which method may be: a.) A maximum likelihood estimate of a second GMM based upon the measures of central tendency of conductance segments of claim 3 above or; b.) A peak finding by means of interpolation and smoothing of the empirical probability density of the estimates of central tendencies of segments of the conductance times series by the means of claim 3 and finding roots of the derivatives of the interpolating functions; c.) Another means of locating the modes of multimodal distribution estimator; d.) Other methods of histogram peak finding well known to those reasonably skilled in the arts.

These and other features, aspects and advantages of the present invention will become better understood with reference to the following drawings, description and claims.

### BRIEF DESCRIPTIONS OF THE DRAWINGS

The following figures, which may be idealized, may not to scale and are intended to be merely illustrative and non-limiting.

FIGS. 1(a)-1(e) show a general scheme for sizing molecules or analytes;

FIGS. 2(a)-2(d) show an example of determining an analyte sample size (or mass) distribution from a current time series with signal processing;

FIG. 3 shows a calibration and confirmation of an analyte size determination method;

FIG. 4 shows a classification of the reduced-conductance pulses and assigning conductance states with a decoding algorithm;

FIG. 5 shows a CDHMM/GMM/Viterbi embodiment of the high-resolution conductance spectrometry method;

FIG. 6 shows a sliding window embodiment of the high-resolution conductance spectrometry method;

FIG. 7 shows a threshold detection of reduced conductance pulses and conductance averaging embodiment of a conductance spectrometry method; and

FIG. 8 is a simplified view of a single nanopore conductance mass spectrometry apparatus.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific aspects only. In other cases it will be recognized that references to the “invention” will refer to subject matter recited in one or more, but not necessarily all, of the claims. Each of the inventions is described in greater detail below, including specific aspects, versions and examples, but the inventions are not limited to these aspects, versions or examples, which are included to enable a person having ordinary skill in the art to make and use the inventions when the information in this patent is combined with available information and technology.

Various terms as used herein. To the extent a term used in a claim is not defined herein, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable and any ranges shall include iterative ranges falling within the expressly stated ranges or limitations.

A method is disclosed for molecular size spectrometry exploiting the interaction between a nanometer-scale pore in a resistive barrier separating two reservoirs of conductive fluid and analyte molecules suspended in at least one of the reservoirs. When resident in the pore, or proximate to the pore, analyte molecules may cause reduced-conductance pulses in the current flow through the pore. Methods for computational techniques to develop a high-resolution conductance spectrogram from these reduced-conductance pulses are also described. For certain molecules, this spectrum may correlate with existing MALDI-TOF mass spectrometry, and it may be calibrated to molecular sizes (or masses). An extended method for two-dimensional processing by forming a vector of resistive pulse amplitudes and pulse lifetimes, for improved analyte discrimination is also described.

The motion of individual molecules that enter the nanopore may be inhibited by physical or chemical interactions to permit analytical conductance-based measurements of separate events. Biological channels in lipid bilayers, for example, may be used to detect and quantitate a variety of analytes, including H⁺ and D⁺ in solution, single-stranded RNA and DNA, small organic molecules, specific sugar molecules, poly(ethylene glycol) (PEG), anthrax toxins, and other analytes. In addition, solid-state silicon nitride nanopores may be used to detect individual double-stranded DNA molecules, for example.

PEG may be used to estimate the size of biological ion channels. Earlier studies demonstrated that PEGs small enough to enter the Staphylococcus aureus alpha-hemolysin nanopore decrease the single-channel conductance (e.g., Krasilnikov, et al., 1992; Bezrukov, et al, 1996; Movilineau and Bayley, 1999; Bezrukov and Kasianowicz, 2002; Krasilnikov, 2002). The mean residence times of PEGs in this channel increase with electrolyte concentration (Bezrukov, et al, 1996; Bezrukov and Kasianowicz, 2002; Krasilnikov, et al., 2006). As described here, the ability to increase analyte residence time in a single nanopore beyond the diffusion limit enables the discrimination of each species or analyte, on the basis of molecular size or mass, within a homologous series of analyte molecules with nearly baseline resolution.

An embodiment of the invention comprises a means to estimate the mass or size of individual molecules in solution. The method is based on the ability of individual molecules to partition into a nanometer-scale pore and thereby to reduce the pore's ionic conductance. The magnitude of the current reduction, and the residence time of the analyte in the pore are both dependent on the analyte size. The frequency in which the current is reduced may be proportional to the concentration of the analyte. The pores may be modified to interact selectively with particular analytes to alter the interaction times. This selectivity permits both the detection of desired analytes at low concentration in the presence of other molecules at high concentration and improved conductance measurement precision.

At the single-molecule nanometer scale, specific signal delineation, and conductance estimation methods may be necessary to resolve the molecular size (or mass) spectra, because current flow may be as small as a few hundred ions per microsecond during analyte-induced resistive pulses. Therefore the ionic currents might contain significant noise because of the fluctuation of the ion concentrations in or proximate the pore. The signal estimation methods of the invention may be embodied in a variety of statistical estimators of the magnitudes (and patterns) of the individual resistive pulses.

The high-resolution set of analyte-induced resistive-pulse conductance levels, together with the level-specific segment lifetimes may provide a two-dimensional extended method of analysis for molecules in solution.

An apparatus and method for the two-dimensional mass spectrometry in solution that is based on the interaction between a nanometer-scale pore and analytes are provided with aspects of the present invention. As an example, poly(ethylene glycol) molecules that enter a single α-hemolysin pore cause distinct mass-dependent conductance states with characteristic mean residence times. The conductance-based mass spectrum may resolve the repeat unit of ethylene glycol, and the mean residence time may increase monotonically with the poly(ethylene glycol) mass. This technique may be useful for the real-time characterization of molecules in solution.

A method is disclosed for molecular size spectrometry exploiting the interaction between a nanometer-scale pore in a resistive barrier separating two reservoirs of conductive fluid and analyte molecules suspended in one or both of the reservoirs. When resident in or proximate to the pore, analyte molecules may cause reduced-conductance pulses in the current flow through the pore. Methods for computational techniques to develop a high-resolution conductance spectrogram from these reduced-conductance pulses are also described. For certain biomolecules, this spectrum is correlated with existing MALDI-TOF mass spectrometry, and it may be calibrated to molecular sizes (or masses). An extended method for two-dimensional processing by forming a vector of resistive pulse amplitudes and pulse lifetimes, for improved analyte discrimination is also described.

The natural useful limit of the capillary diameter is the size of the molecules of interest, and biological ion channels have diameters and lengths commensurate with molecular dimensions. The characteristic time for a molecule to diffuse the length of such pores (˜10 nm) is 50 to 500 ns, which may be inaccessible for meaningful conductance measurements. Thus, the motion of individual molecules that enter the pore may be inhibited by physical or chemical interactions to permit analytical conductance-based measurements of separate events.

PEG has been used to estimate the size of biological ion channels. Earlier studies demonstrated that PEGs small enough to enter the Staphylococcus aureus α-hemolysin (aHL) nanopore decrease the single-channel conductance. The mean residence times of PEGs in this channel increase with electrolyte concentration. As shown herein, the sufficiently long polymer pore interaction time enables the discrimination of each species within a homologous series of PEG molecules with nearly baseline resolution.

As by way of example, solvent-free planar lipid bilayer membranes were formed from diphytanoyl phospatidylcholine (1,2-diphytanoyl-sn-glycero-3-phosphocholine; Avanti Polar Lipids, Alabaster, Ala.) in pentane (J. T. Baker, Phillipsburg, N.J.) on an ˜70-μm diameter hole in a 25-μm thick Teflon partition that separates two identical Teflon chambers. The hole was pretreated with a solution of 1:400 vol/vol hexadecane (Aldrich, St. Louis, Mo.) in pentane. Both chambers contained 4 M KCl (Mallinckrodt, Paris, Ky.), 5 mM 2-amino-2-hydroxymethyl-1,3-propanediol (Tris; Schwarz/Mann Biotech, Cleveland, Ohio), adjusted to pH 7.5 with concentrated citric acid (Fluka, Buchs, Switzerland).

Single channels were formed by adding ˜0.25 μg of 60 HL (List Biological Laboratories, Campbell, Calif.) to the solution on one side of the partition. After a single channel formed, the first chamber was rapidly flushed with fresh buffer to prevent further channel incorporation. Unless otherwise stated, the data were obtained with an applied potential of −40 mV with two Ag/AgCl electrodes separated from the bulk electrolyte by Vycor salt bridges (3 M KCl). The current was measured using an Axopatch 200B patch-clamp amplifier (Molecular Devices, Sunnyvale, Calif.) and filtered at 10 kHz with a four-pole Bessel filter before digitization at 50 kHz.

The αHL toxin may form at least two conformers that have different conductance levels and gating properties. Only the higher conductance conformer was used here, which has an approximately ohmic conductance of 3.75 nS between ±50 mV (data not shown). PEG (polydisperse PEG 1500; Fluka; or monodisperse PEG 1294; Polypure, Oslo, Norway) was added to the second chamber from stock solutions of 12 mg/ml in electrolyte to a final concentration of 0.045 mg/ml.

MALDI-TOF mass spectra of the PEG samples were obtained with a Voyager DE-STR (PerSeptive Biosystems, Framingham, Mass.) by using the reflectron mode. Desorption/ionization was produced by irradiation with pulsed UV light (337 nm) from a nitrogen laser. The instrument was operated at 25 kV in the positive ion mode by using an extraction delay time set at 600 ns. The final spectra were averaged from 100 shots while moving the laser over the surface of the sample with the laser power set slightly over the threshold for the appearance of each spectrum. The samples were prepared from 1% wt/wt PEG solutions in distilled water. The matrix solution was 1:1 acetonitrile:water saturated with all-trans-retinoic acid (Sigma, St. Louis, Mo.) with 0.1% fluoroacetic acid (Matheson, Joliet, Ill.) added. The sample and matrix were mixed 1:1 to a total volume of 2 μl before drying.

From quantitative mixtures of PEGs with different nominal molecular weights, the instrumental sensitivity variation was <20% over the range 1,000 units to 10 kilounits. As a result, the instrument sensitivity changes may be ignored over molecular weight distributions for the nominal molecular weights used here; that is, the relative response to all n-mers in a sample are considered equal within experimental error.

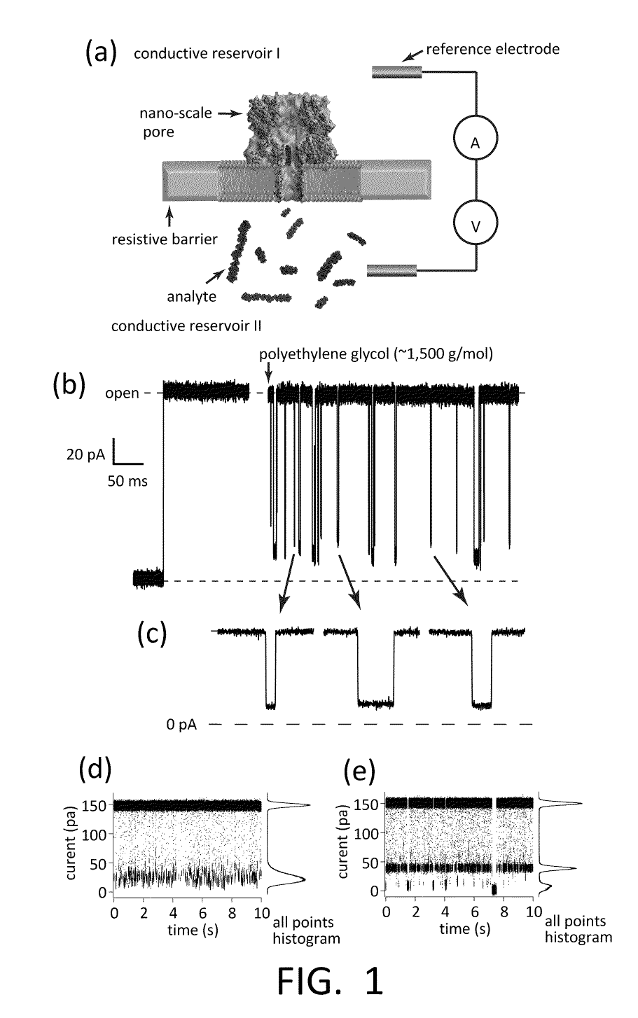

The invention describes physical means, and statistical methods to measure the sizes (or masses) of individual molecules in solution with high fidelity and concentration of the molecules in solution. A representation of one embodiment of the experimental part of the invention is shown in FIG. 1, by way of example. In that case a single nanopore was formed by an ion channel-forming protein (S. aureus alpha-hemolysin). This self-assembling nanopore makes an aperture (minimum diameter d˜1.5 nm) in a resistive barrier (in the case of FIG. 1, a lipid bilayer membrane).

FIGS. 1(a)-1(e) show a general scheme for sizing molecules. FIG. 1(a) shows a solitary nanopore spanning a resistive barrier separating two liquid conductive solution reservoirs. An electrical potential applied across the barrier causes a current to flow through the pore (FIG. 1(b), left). Individual analyte molecules enter the pore and cause transient current decreases (FIG. 1(b), right). For the case of PEG (i.e., poly(ethylene glycol)) as the analyte and the protein S. aureus alpha-hemolysin as the nanopore, single PEG molecules cause well-defined current reductions (FIG. 1(b), right and FIG. 1(c)). Cursory examination of many reduced-conductance pulses caused by polydisperse PEG (mean molecular mass M_{w}˜1500 g/mol) FIG. 1(d), and a chemically purified PEG (˜95% 1294 g/mol) FIG. 1(e) shows that the two samples are distinguishable, thus suggesting a method of determining the size of the molecule based on the current reduced-conductance pulse amplitudes and durations. However, an all-points histogram analysis of >10⁵ reduced-conductance pulses caused by polydisperse PEG (FIG. 1(d), right) may not resolve the individual components in the sample.

Typical single-channel recordings in the absence, FIG. 1(b), left, and presence, FIG. 1(b), right, of PEG are shown. A large ionic current flows through a single αHL channel (I=150 pA±2.6 pA, P=0.001; for V=+40 mV, 4 M KCl, no PEG; FIG. 1(b), left). A polydisperse PEG sample (pPEG) [HO(CH₂CH₂O)ₙH, 25<n<50] added to the solution causes transient, partial-current reduced-conductance pulses (FIG. 1(a) and FIG. 1(b), right)). Each decrease and subsequent increase in the ionic current corresponds to a single PEG molecule entering and exiting the pore, respectively. The duration of a reduced-conductance pulse event is the residence time of the polymer in or proximate the pore. The PEG-induced reduced-conductance pulses are widely distributed in both conductance and residence time (FIG. 1(b), right and FIG. 1(c)).

In the absence of analyte, the ionic current caused by a DC potential is well defined (FIG. 1(b), left). The intrinsic noise in the ionic current may be caused in part by the Brownian motion of ions in the nanopore and the resistive barrier capacitance. The addition of analyte (in this embodiment, poly(ethylene glycol)) causes well-defined transient decreases in the conductance (FIGS. 1(b), right and 1(c)). Each pulse may correspond to the presence of a single PEG molecule in the nanopore. The current reductions cover a range of only ˜50 picoamperes for a polydisperse PEG-1500 sample (average molecular mass ˜1500 g/mol). Although the conductance reductions are characteristic of the polymer sizes and distributions (e.g., compare the ionic current time series for polydisperse PEG-1500 and monodisperse PEG1294 in FIGS. 1(d) and 1(e), respectively), a standard all-point histogram statistical analysis of the current times series may not resolve the conductance pulses caused by differently sized PEG molecules in the polydisperse sample (FIG. 1(d)).

Nonelectrolyte polymers cause well-defined reductions in the ionic current as they partition into a solitary nanopore in a lipid bilayer membrane. (FIG. 1(b) Left) The ionic current, through an αHL channel bathed by a polymer-free solution, is quiescent. Addition of polydisperse PEG (Mᵣ=1,500 g/mol) (FIG. 1(a)) cause persistent current reduced-conductance pulses (FIG. 1(b) right and FIG. 1(c)). The solutions bathing the membrane contained 4 M KCl and 5 mM Tris buffer, pH 7.5. The horizontal dashed lines in FIG. 1(b) and FIG. 1(c) indicate zero current.

A single nanopore discriminates between polymers with different molecular masses. The difference between the conductance states caused by polydisperse (Mᵣ=1,500) (FIG. 1(e), left) and monodisperse (M=1,294 g/mol, n=29) (FIG. 1(d), left) PEG is readily apparent. The time series data shown contained ˜500 and ˜700 events for the poly- and monodisperse PEG samples, respectively. (FIG. 1(d), right and FIG. 1(e), right). All-points histograms of the ionic current reflect the distinct natures of the two polymer samples. The ionic current histograms for each sample were calculated from >105 reduced-conductance pulse events. The long-lived, small ionic current reduced-conductance pulses near zero in the monodisperse PEG time series are most likely caused by impurities in the PEG samples. These events are long-lived but few in number.

A larger sample of reduced-conductance pulses (FIG. 1(e), ˜700 events) illustrates the marked differences between current reduced-conductance pulses caused by pPEG (FIG. 1(d) monodisperse PEG (mPEG) 1294 (n=29, FIG. 1(e)). The all-points histograms of the ionic current (FIGS. 1(d), right and 1(e), right) demonstrate that pPEG may be distinguished easily from mPEG. The histogram from a significantly longer time series with >10⁵ events may not resolve the individual molecular species, even though visual inspection of the reduced-conductance pulse events suggests that distinct conductance states exist. Although the conductance states of many reduced conductance pulses associated with the residence of an analyte molecule in the pore are distributed as single Gaussians, the individual pulses in the raw conductance time series still may not be accurately decoded using a Gaussian mixture model (GMM) fit using expectation maximization (EM) because of the high degree of overlap of the states comprising different pulses. Also, in some cases, single reduced conductance pulses are composed of two or more statistically stationary segments requiring a multi-Gaussian state mixture distribution to properly decode the morphology of these pulses.

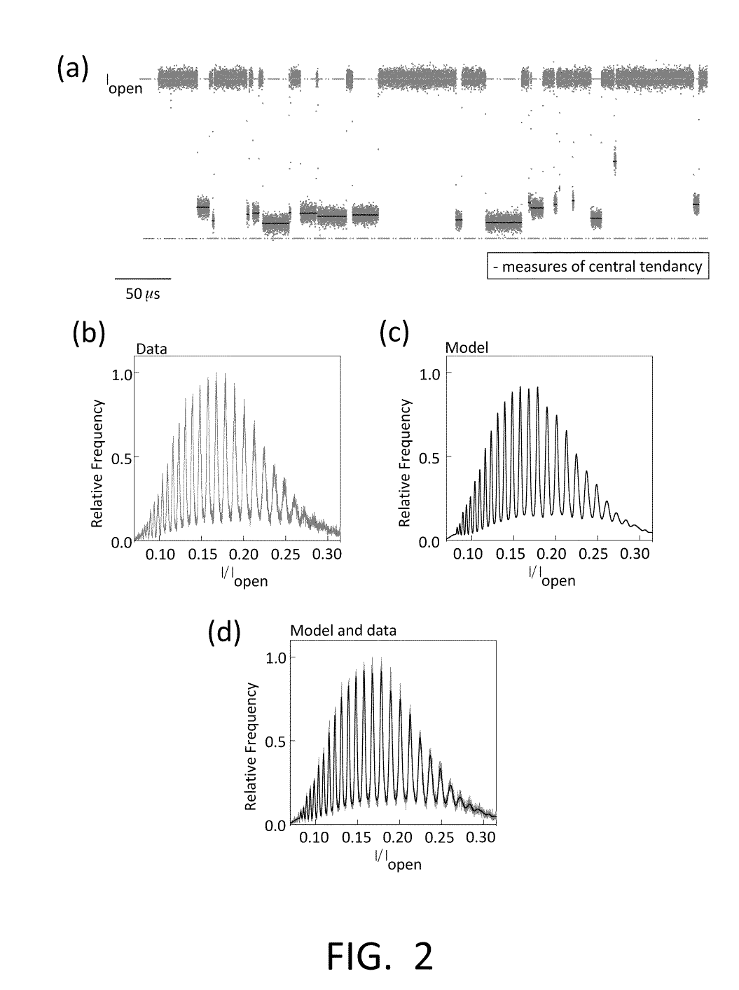

FIGS. 2(a)-2(d) show an example of determining the analyte sample size (or mass) distribution from the current time series with signal processing. FIG. 2(a) shows a high resolution view for part of the ionic current time series in FIG. 1(d) which shows that the current reduced-conductance pulse amplitudes caused by individual molecules in the polydisperse PEG1500 sample are highly overlapped. The black lines or dashes illustrate the maximum likelihood estimation of the central tendency for each PEG-induced current reduced-conductance pulse. Analyzing each reduced-conductance pulse by a measure of statistical central tendency (e.g., the mean current value for PEG-induced current reductions) leads to a distribution of mean current reduction values, shown in FIG. 2(b), which clearly exhibits current reduced-conductance pulse peaks, each characteristic of a particular size analyte. The data may be further processed by modeling it with other statistical algorithms. For example, a Hidden Markov Model/Gaussian Mixture Model (HMM/GMM) applied to the time series of polydisperse PEG-1500 induced reduced-conductance pulses correctly identifies the major peaks (FIG. 2(c), model fit only, and FIG. 2(d), data and model fit) and may be used to determine the size (or mass), and concentration of each analyte in a polydisperse mixture. Depending on the nature of the signals caused by the analytes, other statistical methods may be used to create the analyte size (or mass) spectrum and fit the peaks for precise size estimation.

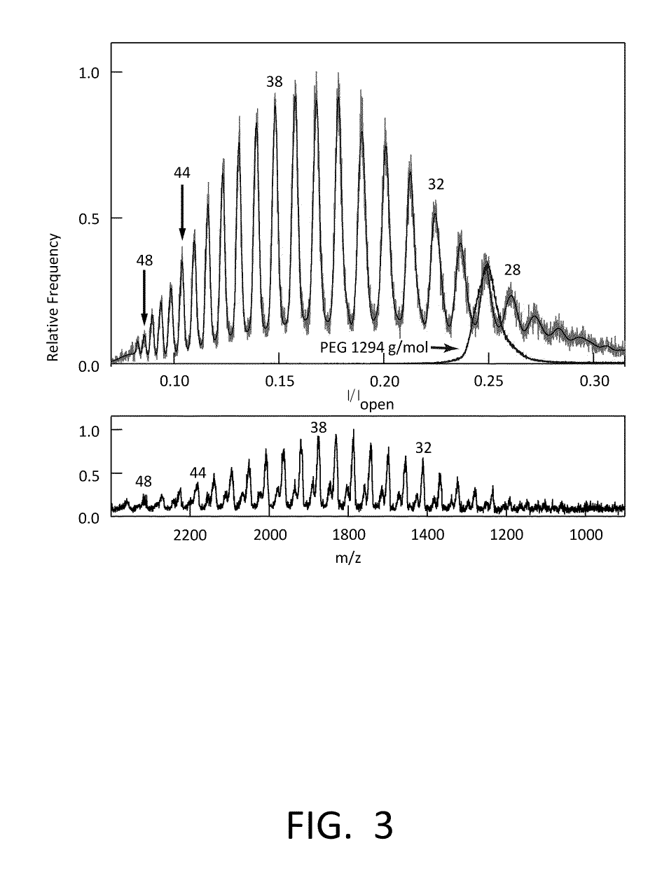

FIG. 3 shows a calibration and confirmation of a size determination method. Calibration of the mass or size spectrum may be accomplished by several techniques. For example, repeating the conductance-based experiment using a standard-size analyte (in this case, chemically-purified PEG 1294 g/mol, labeled histogram) allows assignment of the PEG 1294 g/mol peak in the polydisperse sample indicated as the polydisperse sample data (FIG. 3, upper, grey). Neighboring peaks in the conductance-based histogram are caused by PEG molecules that differ by a single ethylene glycol unit (i.e., CH₂—CH₂-O). A comparison of the conductance-based size distribution (FIG. 3, upper) to a MALDI-TOF mass spectrum of the same polydisperse PEG sample (FIG. 3, lower), demonstrated accuracy of this method.

FIG. 3, upper, illustrates a method for calibrating the conductance spectrogram to molecular size (or mass). While it may be possible to calculate molecular size from ab initio molecular modeling, the conductance-based device may be directly calibrated by adding a chemically-purified calibrant (in the example case, PEG-1294). The direct comparison of the conductance spectrogram from chemically purified PEG, to polydisperse PEG calibrates the system for molecular size (which in this example is correlated to mass). To further demonstrate this method, a conductance spectrogram was compared to a MALDI-TOF mass spectrogram of the same polydisperse PEG sample (FIG. 3, lower).

To resolve and accurately fit the individual components within the mixture, each reduced-conductance pulse event was represented by its mean current value. A histogram made from the mean reduced-conductance pulse currents resolves ˜24 differently sized PEGs (FIG. 3, upper, grey). The mean current histogram for mPEG 1294 (n=29) shows a primary peak at I/Iₒₚₑₙ=0.250±0.005 with a small anisotropy on the higher current side, i.e., lower mass (FIG. 3, upper, PEG 1294 g/mol). The mPEG histogram provides a correlate of PEG molecular mass, thus calibrating the mean current histogram into a mass spectrum. The 1:1 correspondence between this histogram and a MALDI-TOF mass spectrogram for the same pPEG sample (FIG. 3, lower) demonstrates the accuracy of a solitary nanopore as a molecular sizing device.

Mass distributions obtained with a single nanopore (FIG. 3, upper) is compared with a conventional MALDI-TOF mass spectrum (FIG. 3, lower) for polydisperse PEG (Mᵣ=1,500 g/mol). Greater values of I/Iₒₚₑₙ correspond to lower PEG molecular masses. The histogram of the state-averaged current (FIG. 3, upper, grey) are overlaid with the GMM fit (FIG. 3, upper, black). The model fits the empirical probability density function well with a Kolmogorov-Smirnov goodness of fit statistic, KS=0.295. The mean conductance-based histogram for monodisperse (FIG. 3, upper, PEG 1294 g/mol) is scaled to the height of the corresponding polydisperse peak. In the MALDI-MS, under the desorption/ionization conditions used, each PEG n-mer yields a parent ion peak, MH⁺, and a base peak 16 to 17 units lower in mass, suggesting a loss of —O or —OH.

Although the event-mean histogram visibly resolves each component in the pPEG mixture, additional statistical techniques may be required to extract key features, such as peak amplitudes, precise peak position, and characteristic residence time of each size of polymer in the pore. To provide an unbiased analysis and ensure a fit, an automated GMM fitting procedure with more components than the number of visually identifiable peaks was used. The resultant GMM fits the empirical probability density function (FIG. 3, upper, solid black). Of the initial 100 components, the statistical procedure rejected 57 components because of two criteria: low mixture weight (53 components) and excessive width (4 components). The low mixture weight components are insignificant with respect to the total fit, whereas the broad peaks represent an unresolved baseline. The remaining 43 narrow Gaussians are used to assign each individual reduced-conductance pulse event to its most likely conductance state by using a maximum likelihood rule. Approximately 25% of the conductance states include a second, minor Gaussian to provide an adequate statistical fit.

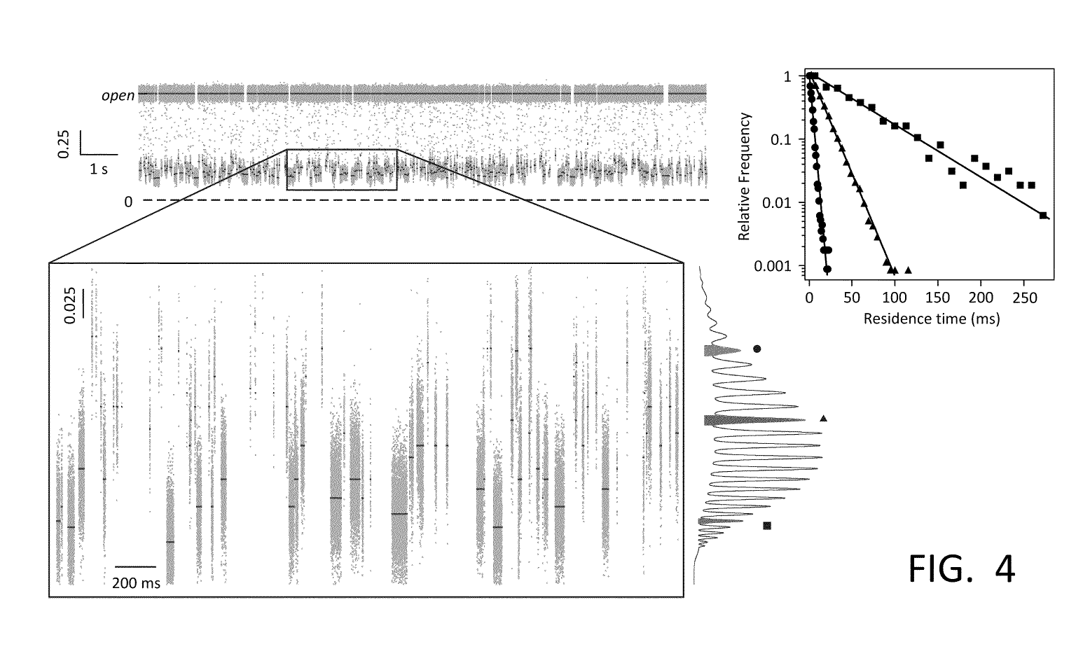

FIG. 4 shows a classification of the reduced-conductance pulses (FIG. 4, grey data points) and assigning conductance states with a decoding algorithm (e.g., HMM/GMM/Viterbi decoder, FIG. 4 black model fit lines) to estimate the residence time of each individual analyte molecule in the pore. The residence time distributions for three differently-sized PEG molecules in the polydisperse PEG-1500 sample are shown (FIG. 4 inset, right). The lifetime distributions for a particular size PEG molecule is well described by a single exponential. Larger PEG molecules reduce the current more and reside in the pore longer (on average) than do smaller PEGs. Thus, the current reduction amplitude histogram and residence time distribution data provide two independent estimators for analyte size (or mass). Because the mean residence time is characteristic of the chemical interactions between the analyte and the pore, the residence time distributions may also be used to discriminate between different analytes and/or analyte classes. The mean residence times for PEG-1294, -1558 and -2042 g/mol in the polydisperse PEG sample were (FIG. 4 inset, right, in ms): (3.2+/−0.1 filled circles), (13.4+/−0.1 filled triangles) and (52+/−2 filled squares).

Residence-time distributions associated with each polymer species vary systematically with the polymer mass. The derived residence time distributions are shown on a semilog plot for three representative states corresponding to the 1,294 (filled circles), 1,558 (filled triangles), and 2,042 (filled squares) g/mol components of pPEG. The mean residence times, estimated from a least-squares fit of a single exponential to each data set are (in milliseconds) as follows: (3.2±0.1), (13.4±0.1), (52±2) for pPEG 1294, pPEG 1558, and pPEG 2042, respectively.

FIG. 4 shows the use of a GMM estimator of the event conductance distribution as a maximum likelihood classifier for the individual reduced-conductance pulse measurements of central tendency. In the case of PEG as the analyte, it was possible to classify each event in terms of the mean current value and duration (i.e., the residence time of each PEG molecule in the nanopore) as shown FIG. 4, bottom, left). The distribution of residence times for each characteristic amplitude, determined with the HMM/GMM/Viterbi decoding technique, and demonstrates that the time a given size PEG molecule spends in the pore depends on its size (or mass). The average residence times of the larger molecular species were longer than those of the smaller molecular species.

FIG. 4 illustrates a typical assignment of the averaged individual current reduced-conductance pulses (FIG. 4, grey points) to the GMM states (FIG. 4, black lines) by using a simplified hidden Markov model decoding procedure. This process permits the estimation of the residence times for each PEG-induced current reduced-conductance pulse state and thus for each polymer size. The detailed view of the time series (FIG. 4, lower) shows that the larger polymers spend more time in the pore than do the smaller ones. The residence time distribution for each polymer in the homologous series is exponential (FIG. 4, inset, right, 3 of the 24 residence-time distributions shown). This result suggests first-order binding kinetics between the polymers and the nanopore. The ability to identify the residence time for the mass of each analyte provides a second discriminant for multivariate analyses of aqueous molecular species.

FIG. 4 shows the current through a solitary nanopore discriminates between individual PEG polymers that have different molecular masses. Ionic current reduced-conductance pulses caused by individual molecules are assigned to Gaussian states of the nanopore mass spectrogram (FIG. 3, upper). The GMM permits assignment of individual reduced-conductance pulses to the conductance states by maximum likelihood decoding (FIG. 4, upper, solid black lines). A 15-second-long block of data showing the open channel and reduced-conductance pulse states. Expansion of the time series data in the highlighted region (FIG. 4, lower left) compared with a histogram made from the GMM fit (FIG. 4, lower right).

We have shown a technique for mass discrimination by using a solitary molecular scale pore. Multivariate discriminants may enable analysis of numerous species in solution on the basis of molecular size and chemical functionality of the analytes. This single-molecule analysis technique may be useful for the real-time characterization of biomarkers (i.e., nucleic acids, proteins, or other biopolymers). With automated, unsupervised analytical and statistical methods, this technique may provide a viable generalized analytical technique with nanopore arrays containing nanopores both with specific affinities for single biomarkers and with nonspecific transducers such as αHL, for example. In situ monitoring of cellular metabolism with such arrays may provide the sensitivity to monitor subtle changes observed through the release of biomarkers.

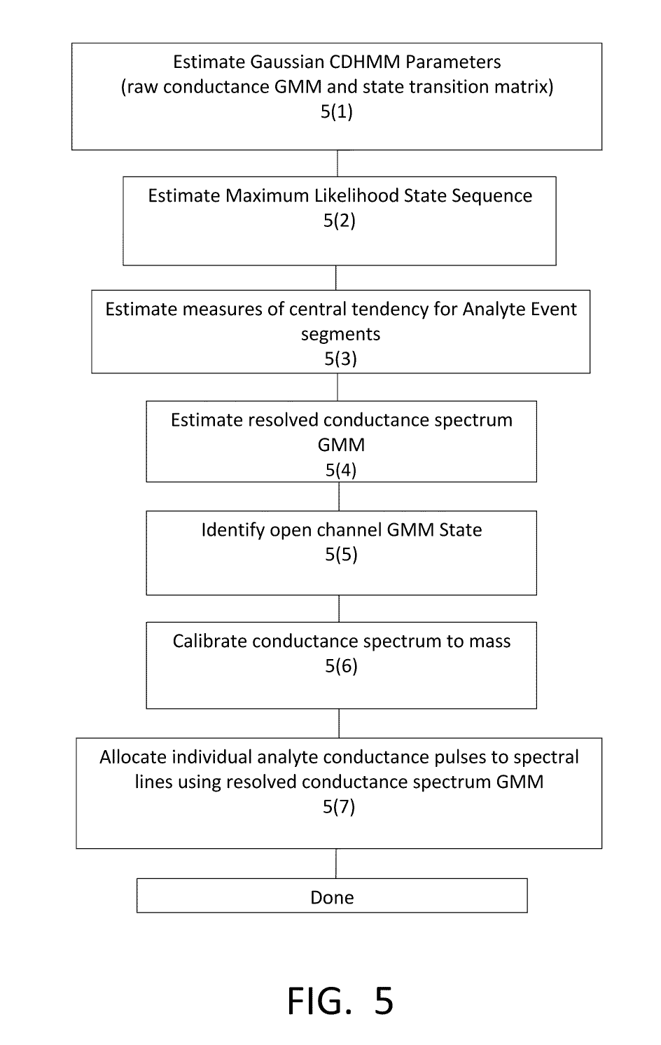

FIG. 5 shows a CDHMM/GMM/Viterbi embodiment of the high-resolution conductance spectrometry method. Firstly, an estimate of the parameters of a CDHMM (comprised of a first GMM based on raw conductance, and state transition matrix) from the raw conductance time series is made at step 5(1). Then an estimate of the maximum likelihood state sequence of the raw conductance time series given the HMM model using the well-known Viterbi decoding procedure is conducted at step 5(2). An estimate of the individual measurements of event/segment central tendency using raw conductance time state sequence to delineate conductance segments is conducted in step 5(3). Event central tendency measurement sets by CDHMM state are aggregated into the resolved conductance spectrum and an estimate of a second GMM based on the measures of central tendency measures of the conductance segments is made at step 5(4). The open channel conductance state is identified in the second GMM by means of a comparison to select the highest conductance level state at step 5(5). Optionally, calibrate resolved conductance spectrum to mass using calibrant spikes as reference may be performed at step 5(6). Individual analyte reduced-conductance pulses are allocated to spectral lines using resolved conductance spectrum second GMM at step 5(7).

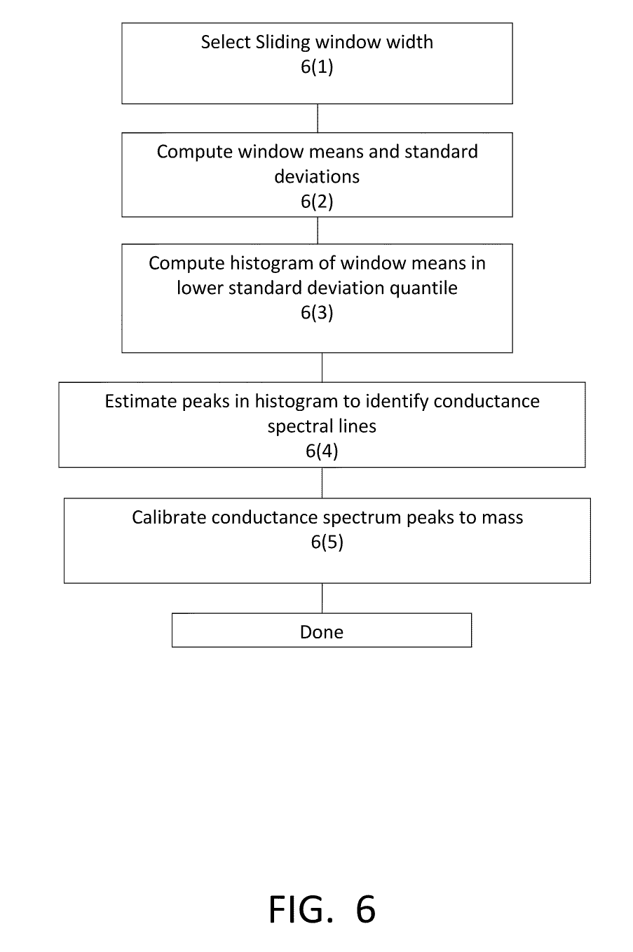

FIG. 6 shows a sliding window embodiment of the high-resolution conductance spectrometry method. A sliding window width is selected for down-sampling by averaging at step 6(1). The mean and standard deviation are computed for each successive window at step 6(2). A quantile level is selected and include the window-means having standard deviations lower than the quantile threshold, and a histogram of the selected window means is computed at step 6(3). Then an estimate of the peaks in the histogram as analyte spectral lines is made at step 6(4), if they are clearly resolved. If peaks are not resolved, then the sliding window width is increased and steps 6(1)-6(4) are repeated. If the window width becomes as large as the average reduced conductance-pulse then the iteration is terminated. Optionally, a calibration of analyte conductance spectral lines to mass relative to reference calibrant spikes of known mass, if they are well resolved, may be conducted at step 6(5).

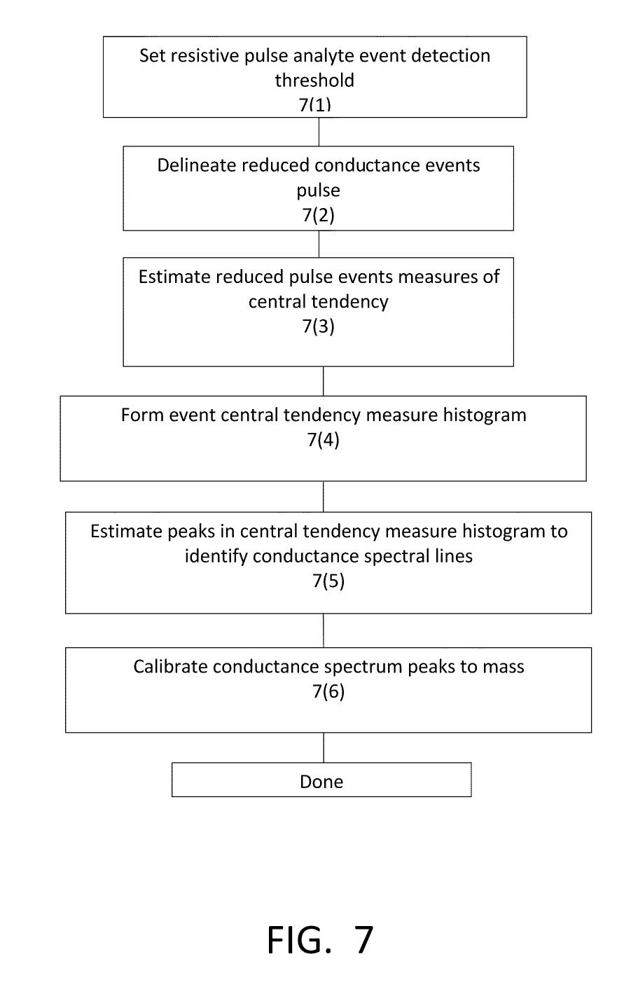

FIG. 7 shows a threshold detection of reduced conductance pulses and conductance averaging embodiment of the conductance spectrometry method. An amplitude threshold is set to provide a means of detecting and delineating reduced-conductance pulses by comparison to the open-pore conductance mean and variance at step 7(1). The regions in the raw conductance time series of reduced-conductance are delineated at step 7(2). Within the delineated reduced-conductance pulse regions, an estimate one of the central tendency measures to represent the pulse conductance amplitude is made in step 7(3). A histogram of measures of central tendency of the reduced-conductance pulses is formed at step 7(4). The pulse histogram is segmented to identify the analyte conductance spectral lines at step 7(5). Optionally, a calibration of analyte conductance spectral lines to mass relative to reference calibrant spikes of known size (or mass) is made at step 7(6).

Other statistical methods may be used to characterize the magnitude of current reduction caused by differently-sized analytes. For the case of PEG molecules shown the noise in the great majority of reduced conductance pulses is Gaussian distributed. In one embodiment of the data reduction, the current time series of each pulse may be represented by their mean values (e.g., FIG. 2(b)) as the measure of central tendency. A histogram of the mean current values for pulses caused by many individual PEG molecules in a polydisperse PEG-1500 sample is shown in FIG. 2(c). This histogram has a distinct appearance of an analyte size (or mass) spectrum. Determining the number and amplitude of the peaks may be determined using other statistical methods (e.g., peak fitting to models for the peak shape, etc.). Several embodiments for the data reduction include the Continuous Density Hidden Markov Model (CDHMM)/Viterbi method (FIG. 5), the sliding window method (FIG. 6), and the threshold detect and averaging method (FIG. 7). Although standard statistical processing methods may be sufficient for some applications of molecule sizing, the CDHMM/GMM/Viterbi decoding method may extract additional information from conductance events that have complex state sequences (i.e., those with multiple and statistically distinct conductance levels within a single event, for averaging of the individual segments rather than aggregating all of an event's data to a single average conductance level.

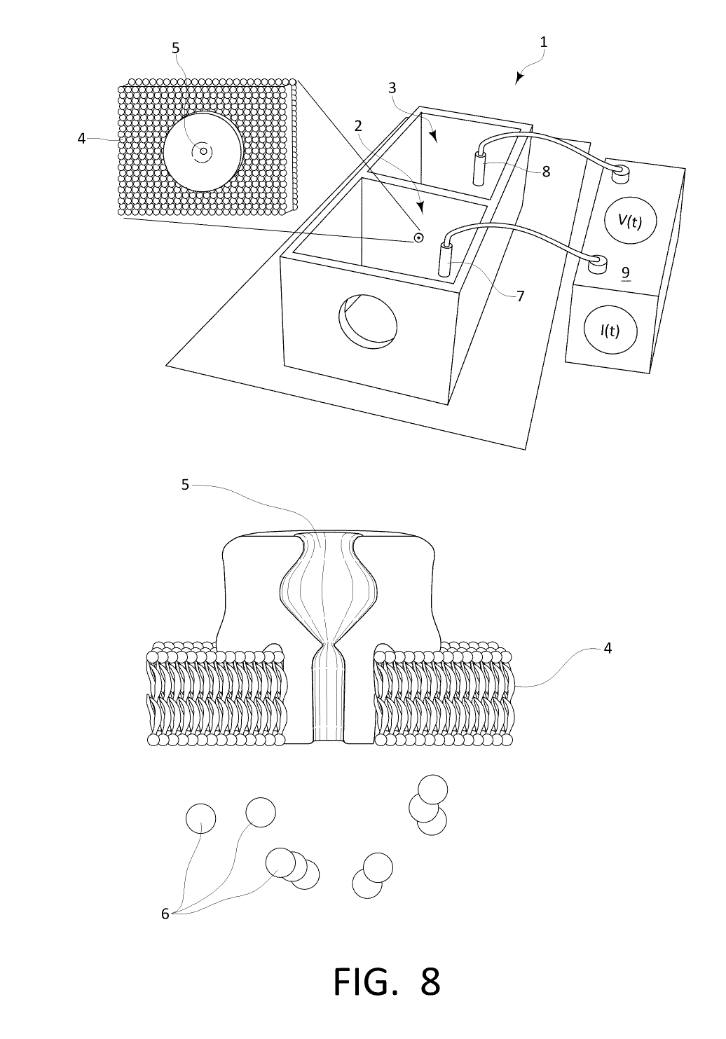

With reference to FIG. 8, a nanopore conductance measurement apparatus 1 is disclosed. Nanopore conductance measurement apparatus 1 comprises a first reservoir 2, having a first electrically conductive fluid, and a second reservoir 3, having a second electrically conductive fluid. The first and second electrically conductive fluids may be the same or different. An electrically resistive barrier 4 separates the first electrically conductive fluid in first reservoir 2 and the second electrically conductive fluid in second reservoir 3. At least one of the first and the second electrically conductive fluids comprises at least one analyte 6 to be measured. A cathode or anode 7 is in the first electrically conductive fluid in first reservoir 2 and the other of a cathode or anode 8 is in the second electrically conductive fluid in second reservoir 3. The barrier 4 comprises at least one nanometer scale pore 5 configured to allow an ionic current to pass between the anode and cathode 7 and 8 upon the application of an electrical potential therebetween. An electrical current measuring device 9 is configured to measure a change in the current passing between the anode and cathode upon the at least one analyte 6 occupying or blocking the at least one nanoscale pore 5.

Nanopore conductance measurement apparatus 1 may have the at least one nanometer scale pore 5 and electrical current measuring device 9 configured to measure a residence time of the at least one analyte 6 within or proximate at least one nanometer scale pore 5. Electrically resistive barrier 4 may be comprised of a lipid membrane, block co-polymer liquid crystal, carbon, silicon, or other materials as are known in the art. Advantageously, barrier 4 has desired electrically resistive properties and is suitable for making nanometer scale pores therethrough. For example, the at least one pore 5 may be a proteinaceous pore or a pore of non-biological origin. An example of a biological origin pore may be a α-hemolysin made pore.

In one aspect of the present invention, a method for determining at least one parameter of at least one analyte 6 in a solution in first reservoir 2 and/or second reservoir 3 is provided. The method comprises placing a first fluid in a first reservoir 2 and placing a second fluid in second reservoir 3. At least one of the first and the second fluids comprise at least one analyte 6. The first fluid in first reservoir 2 is separated from the second fluid in the second reservoir 3 with an electrically resistive barrier 4. Electrically resistive barrier 4 comprises at least one pore 5. An ionic current is passed through the first fluid in first reservoir 2, the at least one pore 5, and the second fluid in second reservoir 3 with an electrical potential between anode and cathode 7 and 8. The ionic current passing through at least one pore 5 is measured with electrical current measuring device 9 for a period of time sufficient to measure a change in the ionic current upon the at least one analyte 6 occupying, interacting, or otherwise reducing the current flowing through the at least one pore 5. At least one parameter of the at least one analyte 6 is then determined by mathematically analyzing the changes in the ionic current over the period of time. The at least one parameter may be the concentration of the at least one analyte in the solution, size, or length (e.g., number of carbon atoms). Advantageously, the ionic current passing through the at least one pore 5 is measured for at least the residence time of the at least one analyte 6 within, proximate, or otherwise interacting with the current flowing through the at least one pore 5. A time course of ionic current may be recorded as a time series including time periods when the at least one pore 5 is void of at least one analyte 6 and periods when at least one analyte 6 cause changes in the ionic current during its residence time effecting the ionic current through the at least one pore 5. Mathematical analysis of the recorded time course may yield at least one parameter of at least one analyte 6, such as size or concentration of the at least one analyte 6, in the first solution, second solution, or both solutions, and/or other desired parameters of the at least one analyte 6.

The mathematical analysis may comprise an Event-Mean Extraction extended to the present case of highly overlapped conductance reduced-conductance pulses caused by a pPEG sample. First, the conductance time series is preprocessed, identifying the reduced-conductance pulses by a 5 σ deviation from the mean open-channel conductance. Because most (>99.5%) of the PEG-induced reduced-conductance pulses may be characterized by a single Gaussian state, the mean value of the reduced-conductance pulse event may be taken as the best estimate of the event amplitude. A histogram of these mean values may be made. In contrast to the unresolved unimodal amplitude distribution of a raw conductance signal shown, a finely resolved structure may be shown in the event-mean amplitudes.

The mathematical analysis may comprise a GMM analysis. To extract reliable measurements from the sample of pPEG event means, a multicomponent GMM may be fit to the sample. Because the expectation-maximization (EM) procedure may converge to an unsatisfactory local maximum, one may start with many more Gaussian components than the number of peaks obvious in the histogram of the event-mean sample. Those assigned low mixture weights (<10⁻⁴) by the EM estimation process may then be discarded. This may result in a GMM fit that may not be rejected at the 0.05 probability level as measured by the Kolmogorov-Smirnov statistic.

The mathematical analysis may also comprise a Maximum Likelihood Event State Assignment. A maximum a posteriori (MAP) state sequence is estimated for the incomplete data, given a hidden Markov model. In the present example, having each event represented by its mean conductance, a uniform transition matrix may be used to reflect no intra-event state transitions for the pPEG event means. This state transition model may incorporate an ergodic and equiprobable state transition matrix into a GMM/hidden Markov model architecture to identify the conductance states and their associated mean amplitudes by maximum likelihood. Assignments may then be made using the Viterbi decoding algorithm. This state assignment procedure partitions the event data into disjoint sets and thus permits estimation of the residence time distributions of PEG-induced conductance states corresponding to each Gaussian mixture component.

Although specific embodiments of the invention have been disclosed, changes may be made to those embodiments without departing from the spirit and scope of the invention. In particular, a variety of physical embodiments of conductive fluids, resistive barriers, nanometer scale pores, as well as statistical estimation procedures may embody the invention. The substitution of allied estimation techniques such as, for example, a Maximum A Posteriori (MAP), for the maximum-likelihood estimators of the preferred statistical signal processing part of the invention may also be made without changing the nature of the invention.

The invention may subsume a number of different phenomena and techniques. The techniques of construction of nanometer scale pores (such as proteinaceous pores in bilayer lipid membranes, or in a silicon substrate, or a carbon nanotube passing through a substrate) are the subjects of current literature but are essential to obtain the conductance time series that are the basis of the analyte conductance size (or mass) spectrum, which spectrum must be resolved with one of a class of statistical estimation procedures for delineation, segmentation, and measurement of central tendency of individual analyte induced reduced-conductance pulses.

Aspects of the present invention may provide apparatuses and methods of molecular size (or mass) spectrometry that functions in liquid phase at single-molecule nanometer scales using small quantities of conductive liquid and a single nanopore (or an array of electrically isolated, independent single nanopores). The methods may employ high-impedance measurement of the ionic current flow through the nanopore. Aspects of the present invention may also provide apparatuses and methods to derive a high-resolution conductance measurement-based size (or mass) spectrum and the identification and location of the peaks in the spectrum via statistical-computational methods. Additionally, aspects of the present invention may provide apparatuses and methods to relate the analyte conductance spectrum to mass by introducing analyte calibrant molecules that may cause identifiable lines or peaks in the analyte conductance-based spectrum. Further, aspects of the present invention may provide methods of non-destructive measurement of the sampled analyte molecules. Also, aspects of the invention may provide an apparatus and method for determining the concentration of an analyte in a solution.

The motion of individual molecules that enter the nanopore may be inhibited by physical or chemical interactions to permit analytical conductance-based measurements of separate events. Thus, aspects of the present invention may leave the molecules in solution and may not require altering the molecules, thus providing a nondestructive analytical method. However, analytes or molecules may be altered and still be within the scope of the present invention. The nanopore method of aspects of the present invention may provide a small sampling volume (on the order of tens of nanometers in each dimension) of any molecular chemical analytical method in solution, at the fundamental sample limit for molecular analysis—a single molecule, without the requirement that the analytes be bound to an immobile surface.

As described herein, the ability to increase analyte residence time in a single nanopore beyond the diffusion limit may enable the discrimination of each species, on the basis of molecular size or mass, within a homologous series of analyte molecules with nearly baseline resolution. Advantageously, the residence time of the analyte interacting with the pore, reducing the ionic current, is greater than the limitations set by the current measurement system bandwidth and the current shot noise.

The invention comprises a means to estimate the mass or size of individual molecules in solution. The method is based, at least partly, on the ability of individual molecules to partition into a nanometer-scale pore and thereby to reduce the pore's ionic conductance. The magnitude of the current reduction, and the residence time of the analyte in the pore may both dependent on the analyte size. The pores may be modified to interact selectively with particular analytes to alter the interaction times. This selectivity may permit both the detection of desired analytes at low concentration in the presence of other molecules at high concentration and improved conductance measurement precision.

At the single-molecule nanometer scale, specific signal delineation, and conductance estimation methods may be necessary to resolve the molecular size (or mass) spectra, because current flow may be as small as a few hundred ions per microsecond during analyte-induced resistive pulses. Therefore the ionic currents might contain significant noise because of the fluctuation of the ion concentrations in the pore. The signal estimation methods of the invention may be embodied in a variety of statistical estimators of the magnitudes (and patterns) of the individual resistive pulses.

The high-resolution set of analyte-induced resistive-pulse conductance levels, together with the level-specific segment lifetimes provide a novel two-dimensional extended method of analysis for molecules in solution. Aspects of this invention, its development, and reduction to practice, may be more completely described in Robertson, J. W. F., Rodrigues, C. G., Stanford, V. M., Rubinson, K. A., Krasilnikov, O. V., Kasianowicz, J. J, Single-molecule mass spectrometry in solution using a solitary nanopore. Proc. Natl. Acad. Sci. (USA) 104, 8207-8211 (2007), incorporated herein in its entirety.

The following patents, patent applications, and publications, are hereby incorporated by reference as if set forth in their entirety herein: Provisional Application No. 61/050,832, entitled “SINGLE MOLECULE MASS SPECTROMETRY IN SOLUTION USING A SOLITARY NANOPORE”, filed May 6, 2008; Robertson et al., May 9, 2007, “SINGLE MOLECULE MASS SPECTROMETRY IN SOLUTION USING A SOLITARY NANOPORE”, Proceedings of the National Academy of Science of the USA., Volume 104, no. 20, pages 8207-8211; U.S. Pat. No. 2,656,508, 20 Oct. 1953, W. Coulter, Means for counting particles suspended in a fluid; U.S. Pat. No. 5,795,782, 18 Aug. 1998, G. Church, D. Deamer, D. Branton, R. Baldarelli, and J. Kasianowicz, Characterization of individual polymer molecules based on monomer-interface interactions; U.S. Pat. No. 6,015,714, 18 Jan. 2000, G. Church, D. Deamer, D. Branton, R. Baldarelli. M. Akeson, and J. Kasianowicz, Characterization of individual polymer molecules based on monomer-interface interactions; U.S. Pat. No. 6,824,659 B2, 30 Nov. 2004, H. Bayley, O. Braha, J. Kasianowicz and E. Gouaux, Designed protein pores as components for biosensors; Akeson, M., Branton, D., Kasianowicz J. J., Brandin, E., Deamer, D. W. Microsecond time-scale discrimination between polycytidylic acid and polyadenylic acid segments within single RNA molecules, Biophys. J. 77, 3227-3233 (1999); Bezrukov, S. M., Vodyanoy, I., Parsegian, V. A. Counting polymers moving through a single ion channel, Nature 370, 279-281 (1994); Bezrukov, S. M., Vodyanoy, I., Brutyan, R. A., Kasianowicz, J. J. Dynamics and free energy of polymers partitioning into a nanoscale pore, Macromolecules 29, 8517-8522 (1996); Bezrukov S. M., Kasianowicz J. J. Dynamic partitioning of neutral polymers into a single ion channel In NATO Advanced Research Workshop: Structure and Dynamics of Confined Polymers, Kluwer Press. Eds. Kasianowicz, J. J., M. S. Z. Kellermayer and D. W. Deamer, pp. 117-130 (2002); Einstein, A. Investigations on the Theory of the Brownian Movement (Dover, N.Y., 1956); Gu, L. Q., Braha O., Conlan, S., Cheley, S., Bayley, H., Stochastic sensing of organic analytes by a pore-forming protein containing a molecular adapter, Nature 398, 686-690 (1999); Halverson, K. M., Panchal R. G., Nguyen T. L., Gussio R., Little S. F., Misakian M., Bavari, S., Kasianowicz J. J., Asymmetric blockade of anthrax protective antigen ion channel by lethal factor: anthrax therapeutic sensor, J. Biol. Chem. 280, 34056-34062 (2005); Heins, E. A., Siwy, Z. S., Baker, L. A., Martin, C. R. Detecting single porphyrin molecules in a conically shaped synthetic nanopore, Nano Lett, 5, 1824-1829 (2005); Henrickson, S. E., Misakian, M., Robertson, B., Kasianowicz, J. J., Driven asymmetric DNA transport in a nanometer-scale pore, Phys. Rev. Lett. 85, 3057-3060 (2000); Ito, T., Sun. L., Crooks R. M. Simultaneous determination of the size and surface charge of individual nanoparticles using a carbon nanotube-based Coulter counter, Anal. Chem., 75, 2399-2406 (2003); Kasianowicz, J. J., Henrickson, S. E., Weetall, H. H., Robertson, B., Simultaneous multianalyte detection with a nanopore, Anal. Chem., 73, 2268-2272 (2001); Kasianowicz, J. J., Brandin, E., Branton, D., Deamer, D. W., Characterization of individual polynucleotide molecules using a membrane channel, Proc. Natl. Acad. Sci. (USA) 93, 13770-13773 (1996); Kasianowicz, J. J., Henrickson, S. E., Misakian, M., Weetall, H. H., Robertson, B., Stanford, V., Physics of DNA threading through a nanometer pore and applications to simultaneous multianalyte sensing, In NATO Advanced Research Workshop: Structure and Dynamics of Confined Polymers, Kluwer Press, Eds. Kasianowicz, J. J., M. S. Z. Kellermayer and D. W. Deamer, pp. 141-163 (2002); Kasianowicz, J. J., Robertson, J. W. F., Chan, E. R., Reiner, J. E., Stanford, V. M. Nanoscopic porous sensors, Ann. Rev. Anal. Chem. 1, 737-766 (2008); Krasilnikov, O. V., Sabirov, R. Z., Ternovsky, V. I., Merzliak P. G., Muratkhodjaev, J. N., A simple method for the determination of the pore radius of ion channels in planar lipid bilayer membranes, FEMS Microbiol Immunol, 5, 93-100 (1992); Krasilnikov O. V. Sizing channels with neutral polymers, In NATO Advanced Research Workshop: Structure and Dynamics of Confined Polymers, eds. Kasianowicz, J. J., Kellermayer, M. S. Z., Deamer, D. W. (Kluwer, Dordrecht, Netherlands NATO Advanced Research Workshop, Structure and Dynamics of Confined Polymers, Kluwer Press., Eds. Kasianowicz, J. J., M. S. Z. Kellermayer and D. W. Deamer, pp. 97-116 (2002); Krasilnikov, O. V., Rodrigues, C. G., Bezrukov, S. M. Single polymer molecules in a protein nanopore in the limit of a strong polymer-pore attraction, Phys. Rev. Lett. 97, 018301 (2006); Kullman L, Winterhalter M, Bezrukov S. M., Transport of maltodextrins through maltoporin: a single-channel study, Biophys. J. 82, 803-812 (2002); Li, J., Stein, D., McMullan, C., Branton, D., Aziz, M. J., Golovchenko, J. A, Ion beam sculpting at nanometre length scales, Nature 412, 166-169 (2001); Mathe, J., Aksimentiev, A., Nelson, D. R., Schulten, K., Meller, A., Orientation discrimination of single-stranded DNA inside the alpha-hemolysin membrane channel, Proc. Natl. Acad. Sci. (USA) 102, 12377-12382 (2005); Movileanu, L., Bayley, H., Partitioning of a polymer into a nanoscopic protein pore obeys a simple scaling law, Proc. Natl. Acad. Sci. (USA) 98, 10137-10141 (2001); Movileanu, L., Cheley, S., Bayley, H., Partitioning of individual flexible polymers into a nanoscopic protein pore, Biophys. J. 85, 897-910 (2003); Robertson, J. W. F., Rodrigues, C. G., Stanford, V. M., Rubinson, K. A., Krasilnikov, O. V., Kasianowicz, J. J, Single-molecule mass spectrometry in solution using a solitary nanopore. Proc. Natl. Acad. Sci. (USA) 104, 8207-8211 (2007); Saleh, O. A., Sohn, L. L., Direct detection of antibody-antigen binding using an on-chip artificial pore, Nano Lett 3, 37-38 (2003); Stanford, V., Kasianowicz, J. J., On quantifying signatures from single-stranded DNA driven through nanometer-scale α-hemolysin ion channels using Hidden Markov Models, IEEE Workshop on Genomic Signal Processing and Statistics, Raleigh, N.C. e-publication, (11-13 Oct., 2002); Stanford, V. M., Kasianowicz, J. J., Transport of DNA through a single nanometer-scale pore: evolution of signal structure, IEEE Workshop on Genomic Signal Processing and Statistics. Baltimore, Md. (e-publication, May 26, 2004); Storm, A. J., Chen, J. H., Zandbergen, H. W., Dekker, C. Translocation of double-strand DNA through a silicon oxide nanopore, Phys Rev E 71:051903 (2005); Vercoutere, W., Winters-Hilt, S., Olsen, H., Deamer, D., Haussler, D., Akeson, M. Rapid, discrimination among individual DNA hairpin molecules at single nucleotide resolution using an ion channel, Nat. Biotechno, 19, 248-252 (2001).

The purpose of incorporating U.S. patents applications and other publications is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

A technique for mass discrimination by using a solitary molecular scale pore is provided. Multivariate discriminants may enable analysis of numerous species in solution on the basis of molecular size and chemical functionality of the analytes. This single-molecule analysis technique may be useful for the real-time characterization of biomarkers (i.e., nucleic acids, proteins, or other biopolymers). With automated, unsupervised analytical and statistical methods, this technique may be viable as a generalized analytical technique with nanopore arrays containing nanopores both with specific affinities for single biomarkers and with nonspecific transducers such as αHL. In situ monitoring of cellular metabolism with such arrays may provide the sensitivity to monitor subtle changes observed through the release of biomarkers.

The invention may provide physical means, and statistical methods to measure the sizes (or masses) of individual molecules in solution with high fidelity. The present application was described herein above with reference to one or more embodiments. It is understood that numerous changes as well as variations are possible, without thereby departing from the spirit and scope of the present application or the underlying thought or thoughts of the present application.

1. A nanopore conductance measurement system comprising:
an electrically resistive barrier separating at least a first and a second electrically conductive fluid;
said electrically resistive barrier comprises at least one nanometer scale pore commensurate in size with at least one analyte molecule in at least one of said first and second electrically conductive fluids;
said at least one nanometer scale pore being configured to allow an ionic current to be driven across said first and second electrically conductive fluids by an applied potential;
said at least one nanometer scale pore comprising a pore surface configured to form associations with the at least one analyte molecule to increase a residence time of the at least one analyte molecule proximate or in said at least one nanometer scale pore;
said at least one nanometer scale pore and said electrically resistive barrier being selected from the group consisting of:
i) said at least one nanometer scale pore comprising a proteinaceous pore or a pore formed by means of molecular biology passing through said electrically resistive barrier, said electrically resistive barrier comprising a bilayer lipid membrane barrier, or other self assembling chemical barrier;
ii) said at least one nanometer scale pore comprising a pore of non-biological origin passing through said electrically resistive barrier, said electrically resistive barrier comprising a biological membrane;
iii) said at least one nanometer scale pore comprising a proteinaceous pore passing through said electrically resistive barrier, said electrically resistive barrier comprising a self assembling block co-polymer resistive barrier;
iv) said at least one nanometer scale pore comprising a void formed by the removal of a portion of said electrically resistive barrier, said electrically resistive barrier comprising an inorganic resistive barrier; and
v) said at least one nanometer scale pore comprising a pore of non-biological origin passing through said electrically resistive barrier, said electrically resistive barrier comprising inorganic resistive material; and
a means of measuring the ionic current and a means of recording its time course as a time series, including time periods when the at least one pore is unobstructed by said at least one analyte molecule and also time periods when said at least one analyte molecule cause pulses of reduced-conductance.

2. The nanopore conductance measurement system of claim 1 wherein said residence time of the at least one analyte molecule proximate or in said at least one nanometer scale pore is greater than limitations of ionic current bandwidth and current shot noise of said means of measuring the ionic current.

3. A method to delineate segments of a conductance time series into regions statistically consistent with the unobstructed pore conductance level, and pulses of reduced-conductance, and also statistically stationary segments within individual pulses of reduced-conductance, said conductance time series being generated with a nanopore conductance measurement system comprising:
an electrically resistive barrier separating at least a first and a second electrically conductive fluid;
said electrically resistive barrier comprises at least one nanometer scale pore commensurate in size with at least one analyte molecule in at least one of said first and second electrically conductive fluids;
said at least one nanometer scale pore being configured to allow an ionic current to be driven across said first and second electrically conductive fluids by an applied potential;
said at least one nanometer scale pore comprising a pore surface configured to form associations with the at least one analyte molecule to increase a residence time of the at least one analyte molecule proximate or in said at least one nanometer scale pore; and
a means of measuring the ionic current and a means of recording said conductance time series, including time periods when the at least one pore is unobstructed by said at least one analyte molecule and also time periods when said at least one analyte molecule cause pulses of reduced-conductance;
said method to delineate segments of a conductance time series being selected from the group consisting of:
a.) a Viterbi decoding of the maximum likelihood state sequence of a Continuous Density of a Hidden Markov Model estimated from the raw conductance time series;
b.) a delineation of the regions of pulses of reduced-conductance via comparison to a threshold for deviation from the open-pore conductance level; and
c) a means to characterize pulses of reduced-conductance by estimating the central tendencies of the ionic current levels for each segment, or by measure of central tendencies and segment duration together, the measure of segment central tendency being selected from the group consisting of:
i) a mean parameter of a Gaussian component of a first GMM estimated from the conductance time series as part of a Continuous Density Hidden Markov Model;
ii) an arithmetic mean;
iii) a trimmed mean;
iv) a median; and
v) a Maximum A Posteriori estimator of sample location, or a maximum likelihood estimator of sample location.

4. The method to delineate segments of a conductance time series of claim 3 further comprising at least one:
a.) a maximum likelihood estimate of a second Gaussian Mixture Model based upon the measures of central tendency of conductance segments;
b.) a peak finding by means of interpolation and smoothing of the empirical probability density of the estimates of central tendencies of segments of the conductance times series and finding roots of the derivatives of the interpolating functions; and
c.) another means of locating the modes of multimodal distribution estimator.

5. A method for determining at least one parameter of at least one analyte in a solution comprising the steps of:
placing a first fluid in a first reservoir;
placing a second fluid in a second reservoir;
at least one of said first and said second fluid comprising at least one analyte;
said first fluid in said first reservoir being separated from said second fluid in said second reservoir with an electrically resistive barrier;
said electrically resistive barrier comprising at least one pore;
passing an ionic current through said first fluid, said at least one pore, and said second fluid with an electrical potential between said first and said second fluid;
measuring the ionic current passing through said at least one pore and the duration of changes in the ionic current;
the measuring of the ionic current being carried out for a period of time sufficient to measure a reduction in the ionic current caused by said at least one analyte interacting with said at least one pore; and
determining at least one parameter of the at least one analyte by mathematically analyzing the changes in the ionic current and the duration of the changes in the ionic current over the period of time;
said mathematical analysis comprising at least one step selected from the group consisting of:
i) a mean parameter of a Gaussian component of a first GMM estimated from the conductance time series as part of a Continuous Density Hidden Markov Model;
ii) an Event-Mean Extraction;
iii) Maximum Likelihood Event State Assignment;
iv) threshold detection and averaging;
v) sliding window analysis;
vi) an arithmetic mean;
vii) a trimmed mean;
viii) a median; and
ix) a Maximum A Posteriori estimator of sample location, or a maximum likelihood estimator of sample location.

6. The method for determining at least one parameter of at least one analyte in a solution of claim 5 wherein the mathematical analysis is selected from the group consisting of GMM, threshold detection and averaging, and sliding window analysis.

7. The method for determining at least one parameter of at least one analyte in a solution of claim 5 wherein the at least one parameter is selected from the group consisting of the concentration of said at least one analyte in one of said first and said second fluid and the size of said at least one analyte.
